(19) United States
(12) Patent Application Publication
(10) Pub. No.: US 2026/0313436 A1
(43) Pub. Date: Oct. 8, 2026

(54) METHOD AND APPARATUS FOR TRANSMISSION OF DATA IN WIRELESS COMMUNICATION SYSTEM

(71) Applicant: Samsung Electronics Co., Ltd., Gyeonggi-do (KR)

(72) Inventors: Sa ZHANG, Beijing (CN); Min WU, Beijing (CN); Feifei SUN, Beijing (CN)

(21) Appl. No.: 19/100,766

(22) PCT Filed: Aug. 1, 2023
(86) PCT No.: PCT/KR2023/011206

§ 371 Date: Feb. 3, 2025

(30) Foreign Application Priority Data
Aug. 3, 2022 (CN) 202210929484.2

(51) Int. Cl. H04W 28/02; H04W 80/02

(52) U.S. Cl. CPC H04W 28/0236; H04W 28/0278; H04W 80/02

(57) ABSTRACT

The present disclosure provides a method performed by a terminal in a wireless communication system, comprising: receiving, a physical downlink channel including configuration information; and transmitting a physical uplink channel, wherein the physical uplink channel includes a physical uplink shared channel and/or a physical uplink control channel (PUCCH).

### TECHNICAL FIELD The disclosure relates to a technical field of wireless communication, in particular to a method and apparatus for transmission of data in a wireless communication system.

### BACKGROUND ART

In order to meet the increasing demand for wireless data communication services since the deployment of 4G communication systems, efforts have been made to develop improved 5G or pre-5G communication systems. Therefore, 5G or pre-5G communication systems are also called “Beyond 4G networks” or “Post-LTE systems”.

In order to achieve a higher data rate, 5G communication systems are implemented in higher frequency (millimeter, mmWave) bands, e.g., 60 GHz bands. In order to reduce propagation loss of radio waves and increase a transmission distance, technologies such as beamforming, massive multiple-input multiple-output (MIMO), full-dimensional MIMO (FD-MIMO), array antenna, analog beamforming and large-scale antenna are discussed in 5G communication systems.

In addition, in 5G communication systems, developments of system network improvement are underway based on advanced small cell, cloud radio access network (RAN), ultra-dense network, device-to-device (D2D) communication, wireless backhaul, mobile network, cooperative communication, coordinated multi-points (COMP), reception-end interference cancellation, etc.

In 5G systems, hybrid FSK and QAM modulation (FQAM) and sliding window su-perposition coding (SWSC) as advanced coding modulation (ACM), and filter bank multicarrier (FBMC), non-orthogonal multiple access (NOMA) and sparse code multiple access (SCMA) as advanced access technologies have been developed.

5G mobile communication technologies define broad frequency bands such that high transmission rates and new services are possible, and can be implemented not only in “Sub 6 GHz” bands such as 3.5 GHz, but also in “Above 6 GHz” bands referred to as mm Wave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mm Wave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user con-venience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is un-available, and positioning.

Moreover, there has been ongoing standardization in air interface architecture/ protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

5th generation (5G) or new radio (NR) mobile communications is recently gathering increased momentum with all the worldwide technical activities on the various candidate technologies from industry and academia. The candidate enablers for the 5G/NR mobile communications include massive antenna technologies, from legacy cellular frequency bands up to high frequencies, to provide beamforming gain and support increased capacity, new waveform (e.g., a new radio access technology (RAT)) to flexibly accommodate various services/applications with different requirements, new multiple access schemes to support massive connections, and so on.

### DISCLOSURE OF INVENTION

### Technical Problem

The present disclosure proposes a method and apparatus relates to improve communication efficiency in a wireless communication system.

The technical subjects pursued in the disclosure may not be limited to the above mentioned technical subjects, and other technical subjects which are not mentioned may be clearly understood, through the following descriptions, by those skilled in the art to which the disclosure pertains.

### Solution to Problem

An apparatus and a method performed by the same in a wireless communication system are provided. The method includes: receiving a physical downlink channel including configuration information; and transmitting a physical uplink channel, where the physical uplink channel includes a physical uplink shared channel (PUSCH) and/or a physical uplink control channel (PUCCH). The invention can improve communication efficiency.

According to at least one embodiment of the disclosure, there is provided a method performed by a terminal in a wireless communication system. The method includes: receiving a physical downlink channel including configuration information; transmitting a physical uplink channel, wherein the physical uplink channel includes a physical uplink shared channel (PUSCH) and/or a physical uplink control channel (PUCCH).

According to at least one embodiment of the disclosure, there is provided a method performed by a base station in a wireless communication system. The method includes: transmitting a physical downlink channel including configuration information to a terminal; and receiving a physical uplink channel from the terminal, wherein the physical uplink channel includes a physical uplink shared channel (PUSCH) and/or a physical uplink control channel (PUCCH).

In some implementations, for example, the configuration information is used to indicate the terminal to report first information related to a transmission delay of uplink data. Receiving the physical uplink channel includes: receiving the first information related to the transmission delay of uplink data reported by the terminal in response to the configuration information on the PUSCH.

In some implementations, for example, the first information includes second information of at least one radio link control (RLC) protocol data unit (PDU) of one or more RLC PDUs. For each RLC PDU of the at least one RLC PDU, the second information includes at least one of:
a first time indicating a time when the RLC PDU arrives at the terminal;
a first packet delay budget (PDB) indicating a latency requirement that a time interval between the first time and a time when the base station successfully receives the RLC PDU needs to be satisfied;
a first remaining PDB obtained by subtracting a time interval between the first time and a time when a media access control (MAC) PDU corresponding to the RLC PDU is transmitted from the first PDB;
a second remaining PDB obtained by subtracting a first predefined time from the first remaining PDB;
a third remaining PDB obtained by subtracting a second predefined time from the first PDB;
a size of the RLC PDU; or
a size of remaining RLC PDUs in a buffer of a logical channel corresponding to the RLC PDU.

In some implementations, for example, each RLC PDU of the at least one RLC PDU satisfies a first predefined condition. For each RLC PDU of the at least one RLC PDU, the first predefined condition includes at least one of: the logical channel corresponding to the RLC PDU satisfying a second predefined condition; or the second information of the RLC PDU satisfying a third predefined condition.

In some implementations, for example, the second predefined condition includes at least one of: the configuration information being used to indicate the terminal to report the second information for the logical channel corresponding to the RLC PDU; or the configuration information being used to indicate the terminal to report the second information for a logical channel group (LCG) to which the logical channel corresponding to the RLC PDU belongs.

In some implementations, for example, the third predefined condition includes at least one of: the first remaining PDB being less than a first predefined threshold; the second remaining PDB being less than a second predefined threshold; the third remaining PDB being less than a third predefined threshold; the first remaining PDB being greater than a fourth predefined threshold; the second remaining PDB being greater than a fifth predefined threshold; or the third remaining PDB being greater than a sixth predefined threshold.

In some implementations, for example, for an RLC PDU of the one or more RLC PDUs, in case that the RLC PDU satisfies a fourth predefined condition: a buffer of a logical channel corresponding to the RLC PDU is flushed; and/or a buffer status reporting (BSR) is triggered; and/or a specific scheduling request (SR) is triggered.

In some implementations, for example, the fourth predefined condition includes at least one of: a first remaining PDB being less than a seventh predefined threshold, wherein the first remaining PDB is obtained by subtracting a time interval between a first time and a time when a MAC PDU corresponding to the RLC PDU is transmitted from a first PDB, wherein the first PDB indicates a latency requirement that a time interval between the first time and a time when the base station successfully receives the RLC PDU needs to be satisfied, and the first time indicates a time when the RLC PDU arrives at the terminal; a second remaining PDB being less than an eighth predefined threshold, wherein the second remaining PDB is obtained by subtracting a first predefined time from the first remaining PDB; or a third remaining PDB being less than a ninth predefined threshold, wherein the third remaining PDB is obtained by subtracting a second predefined time from the first PDB.

In some implementations, for example, in case that a media access control (MAC) protocol data unit (PDU) satisfies a fifth predefined condition, a hybrid automatic repeat request (HARQ) buffer corresponding to the MAC PDU is flushed.

In some implementations, for example, the configuration information includes a dynamic uplink grant indicating retransmission of a HARQ process. In case that a MAC PDU corresponding to the HARQ process satisfies a fifth predefined condition, a PUSCH associated with the dynamic uplink grant is not received.

In some implementations, for example, the configuration information includes a configured uplink grant. In case that a HARQ process is configured for the configured uplink grant and a MAC PDU corresponding to the HARQ process satisfies a fifth predefined condition, at least one of a configured grant retransmission timer or a configured grant timer is stopped.

In some implementations, for example, the fifth predefined condition includes at least one of: at least one or all of radio link control (RLC) PDUs corresponding to the MAC PDU satisfying a sixth predefined condition; or a PUSCH for receiving the MAC PDU being a configured grant (CG) PUSCH.

In some implementations, for example, the sixth predefined condition includes at least one of: a first remaining packet delay budget (PDB) being less than a seventh predefined threshold, wherein the first remaining PDB is obtained by subtracting a time interval between a first time and a time when a MAC PDU corresponding to the RLC PDU is transmitted from a first PDB, wherein the first PDB indicates a latency requirement that a time interval between the first time and a time when the base station successfully receives the RLC PDU needs to be satisfied, and the first time indicates a time when the RLC PDU arrives at the terminal; a second remaining PDB being less than an eighth predefined threshold, wherein the second remaining PDB is obtained by subtracting a first predefined time from the first remaining PDB; or a third remaining PDB being less than a ninth predefined threshold, wherein the third remaining PDB is obtained by subtracting a second predefined time from the first PDB.

In some implementations, for example, the configuration information includes a dynamic uplink grant indicating a hybrid automatic repeat request (HARQ) process.

Receiving the physical uplink channel includes receiving uplink control information (UCI) including information related to the HARQ process on a PUSCH associated with the dynamic uplink grant.

In some implementations, for example, the information related to the HARQ process includes at least one of: a new data indicator (NDI); a modulation and coding scheme (MCS); or a redundancy version (RV).

In some implementations, for example, the configuration information includes a dynamic uplink grant indicating retransmission of a HARQ process. Receiving the physical uplink channel includes: in case that a MAC PDU corresponding to the HARQ process satisfies a fifth predefined condition, receiving a new MAC PDU and uplink control information (UCI) including information related to the new MAC PDU on a PUSCH associated with the dynamic uplink grant.

In some implementations, for example, the information related to the new PDU includes at least one of: an NDI; an MCS; or a RV.

In some implementations, for example, receiving the physical uplink channel includes receiving a physical uplink control channel (PUCCH) carrying information indicating that there is no uplink data from the terminal.

In some implementations, for example, receiving the PUCCH indicating that there is no uplink data from the terminal includes receiving the PUCCH with a negative scheduling request (SR) from the terminal to determine that there is no uplink data to receive.

According to some embodiments of the disclosure, there is also provided a terminal in a wireless communication system. The terminal includes a transceiver; and a controller coupled with the transceiver and configured to perform one or more operations of the above-mentioned methods performed by the terminal.

According to some embodiments of the disclosure, there is also provided a base station in a wireless communication system. The base station includes a transceiver; and a controller coupled with the transceiver and configured to perform one or more operations of the methods performed by the base station.

### Advantageous Effects of Invention

The present disclosure provides an effective and efficient method for communication in a wireless communication system. Advantageous effects obtainable from the disclosure may not be limited to the above mentioned effects, and other effects which are not mentioned may be clearly understood, through the following descriptions, by those skilled in the art to which the disclosure pertains.

### BRIEF DESCRIPTION OF DRAWINGS

In order to illustrate the technical schemes of the embodiments of the disclosure more clearly, the drawings of the embodiments of the disclosure will be briefly introduced below. Apparently, the drawings described below only refer to some embodiments of the disclosure, and do not limit the disclosure, and in the drawings:

FIG. 1 illustrates a schematic diagram of an example wireless network according to some embodiments of the disclosure;

FIGS. 2A and 2B illustrate example wireless transmission and reception paths according to some embodiments of the disclosure;

FIG. 2C illustrates a radio protocol architecture of a next generation mobile communication system according to an embodiment of the disclosure;

FIG. 3A illustrates an example user equipment (UE) according to some embodiments of the disclosure;

FIG. 3B illustrates an example gNB according to some embodiments of the disclosure;

FIG. 4 illustrates a block diagram of a second transceiving node according to some embodiments of the disclosure;

FIG. 5 illustrates a flowchart of a method performed by a UE according to some embodiments of the disclosure;

FIGS. 6A-6C illustrate some examples of uplink transmission timing according to some embodiments of the disclosure;

FIG. 7 illustrates a flowchart of a method 700 performed by a terminal according to some embodiments of the disclosure;

FIG. 8 illustrates a block diagram of a first transceiving node according to some embodiments of the disclosure;

FIG. 9 illustrates a flowchart of a method performed by a base station according to some embodiments of the disclosure; and

FIG. 10 illustrates a flowchart of a method performed by a base station according to some embodiments of the disclosure.

### MODE FOR THE INVENTION

In order to make the purpose, technical schemes and advantages of the embodiments of the disclosure clearer, the technical schemes of the embodiments of the disclosure will be described clearly and completely with reference to the drawings of the embodiments of the disclosure. Apparently, the described embodiments are a part of the embodiments of the disclosure, but not all embodiments. Based on the described embodiments of the disclosure, all other embodiments obtained by those of ordinary skill in the art without creative labor belong to the protection scope of the disclosure.

Before undertaking the DETAILED DESCRIPTION below, it can be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, connect to, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller can be implemented in hardware or a combination of hardware and software and/or firmware. The functionality associated with any particular controller can be centralized or distributed, whether locally or remotely. The phrase “at least one of,” when used with a list of items, means that different combinations of one or more of the listed items can be used, and only one item in the list can be needed. For example, “at least one of: A, B, and C” includes any of the following combinations: A, B, C, A and B, A and C, B and C, and A and B and C. For example, “at least one of: A, B, or C” includes any of the following combinations: A, B, C, A and B, A and C, B and C, and A, B and C.

Moreover, various functions described below can be implemented or supported by one or more computer programs, each of which is formed from computer-readable program code and embodied in a computer-readable medium. The terms “application” and “program” refer to one or more computer programs, software components, sets of instructions, procedures, functions, objects, classes, instances, related data, or a portion thereof adapted for implementation in a suitable computer-readable program code. The phrase “computer-readable program code” includes any type of computer code, including source code, object code, and executable code. The phrase “computer-readable medium” includes any type of medium capable of being accessed by a computer, such as Read-Only Memory (ROM), Random Access Memory (RAM), a hard disk drive, a Compact Disc (CD), a Digital Video Disc (DVD), or any other type of memory. A “non-transitory” computer-readable medium excludes wired, wireless, optical, or other communication links that transport transitory electrical or other signals. A non-transitory computer-readable medium includes media where data can be permanently stored and media where data can be stored and later overwritten, such as a rewritable optical disc or an erasable memory device.

Terms used herein to describe the embodiments of the disclosure are not intended to limit and/or define the scope of the present invention. For example, unless otherwise defined, the technical terms or scientific terms used in the disclosure shall have the ordinary meaning understood by those with ordinary skills in the art to which the present invention belongs.

It should be understood that “first”, “second” and similar words used in the disclosure do not express any order, quantity or importance, but are only used to distinguish different components. Similar words such as singular forms “a”, “an” or “the” do not express a limitation of quantity, but express the existence of at least one of the referenced item, unless the context clearly dictates otherwise. For example, reference to “a component surface” includes reference to one or more of such surfaces.

As used herein, any reference to “an example” or “example”, “an implementation” or “implementation”, “an embodiment” or “embodiment” means that particular elements, features, structures or characteristics described in connection with the embodiment is included in at least one embodiment. The phrases “in one embodiment” or “in one example” appearing in different places in the specification do not necessarily refer to the same embodiment.

As used herein, “a portion of” something means “at least some of” the thing, and as such may mean less than all of, or all of, the thing. As such, “a portion of” a thing includes the entire thing as a special case, i.e., the entire thing is an example of a portion of the thing.

As used herein, the term “set” means one or more. Accordingly, a set of items can be a single item or a collection of two or more items.

In this disclosure, to determine whether a specific condition is satisfied or fulfilled, expressions, such as “greater than” or “less than” are used by way of example and expressions, such as “greater than or equal to”, “greater than or greater than or equal to” or “less than or equal to” or “less than or less than or equal to” are also applicable and not excluded. For example, a condition defined with “greater than or equal to” may be replaced by “greater than” (or vice-versa), a condition defined with “less than or equal to” may be replaced by “less than” (or vice-versa), etc.

It will be further understood that similar words such as the term “include” or “comprise” mean that elements or objects appearing before the word encompass the listed elements or objects appearing after the word and their equivalents, but other elements or objects are not excluded. Similar words such as “connect” or “connected” are not limited to physical or mechanical connection, but can include electrical connection, whether direct or indirect. “Upper”, “lower”, “left” and “right” are only used to express a relative positional relationship, and when an absolute position of the described object changes, the relative positional relationship may change accordingly.

The various embodiments discussed below for describing the principles of the disclosure in the patent document are for illustration only and should not be interpreted as limiting the scope of the disclosure in any way. Those skilled in the art will understand that the principles of the disclosure can be implemented in any suitably arranged wireless communication system. For example, although the following detailed description of the embodiments of the disclosure will be directed to LTE and/ or 5G communication systems, those skilled in the art will understand that the main points of the disclosure can also be applied to other communication systems with similar technical backgrounds and channel formats with slight modifications without departing from the scope of the disclosure. The technical schemes of the embodiments of the present application can be applied to various communication systems, and for example, the communication systems may include global systems for mobile communications (GSM), code division multiple access (CDMA) systems, wideband code division multiple access (WCDMA) systems, general packet radio service (GPRS) systems, long term evolution (LTE) systems, LTE frequency division duplex (FDD) systems, LTE time division duplex (TDD) systems, universal mobile telecommunications system (UMTS), worldwide interoperability for microwave access (WiMAX) communication systems, 5th generation (5G) systems or new radio (NR) systems, etc. In addition, the technical schemes of the embodiments of the present application can be applied to future-oriented communication technologies. In addition, the technical schemes of the embodiments of the present application can be applied to future-oriented communication technologies.

Hereinafter, the embodiments of the disclosure will be described in detail with reference to the accompanying drawings. It should be noted that the same reference numerals in different drawings will be used to refer to the same elements already described.

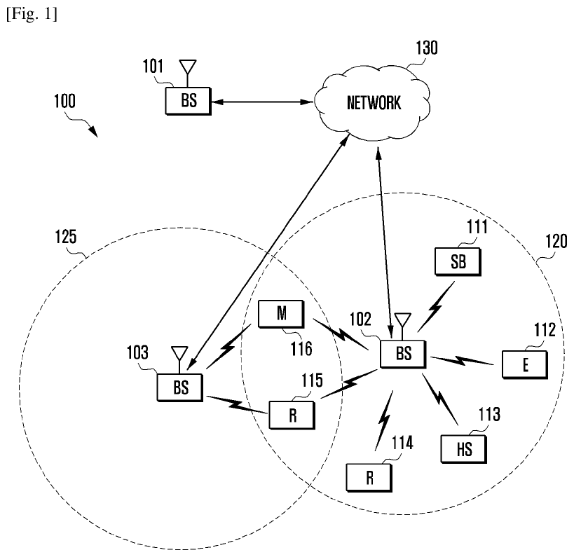

The following FIGS. 1-3B describe various embodiments implemented by using orthogonal frequency division multiplexing (OFDM) or orthogonal frequency division multiple access (OFDMA) communication technologies in wireless communication systems. The descriptions of FIGS. 1-3B do not mean physical or architectural im-plications for the manner in which different embodiments may be implemented. Different embodiments of the disclosure may be implemented in any suitably arranged communication systems.

FIG. 1 illustrates an example wireless network 100 according to some embodiments of the disclosure. The embodiment of the wireless network 100 shown in FIG. 1 is for illustration only. Other embodiments of the wireless network 100 can be used without departing from the scope of the disclosure.

The wireless network 100 includes a gNodeB (gNB) 101, a gNB 102, and a gNB 103. gNB 101 communicates with gNB 102 and gNB 103. gNB 101 also communicates with at least one Internet Protocol (IP) network 130, such as the Internet, a private IP network, or other data networks.

Depending on a type of the network, other well-known terms such as “base station (BS)” or “access point” can be used instead of “gNodeB” or “gNB”. For convenience, the terms “gNodeB” and “gNB” are used in this patent document to refer to network in-frastructure components that provide wireless access for remote terminals. And, depending on the type of the network, other well-known terms such as “mobile station”, “user station”, “remote terminal”, “wireless terminal” or “user apparatus” can be used instead of “user equipment” or “UE”. For example, the terms “terminal”, “user equipment” and “UE” may be used in this patent document to refer to remote wireless devices that wirelessly access the gNB, no matter whether the UE is a mobile device (such as a mobile phone or a smart phone) or a fixed device (such as a desktop computer or a vending machine).

gNB 102 provides wireless broadband access to the network 130 for a first plurality of User Equipments (UEs) within a coverage area 120 of gNB 102. The first plurality of UEs include a UE 111, which may be located in a Small Business (SB); a UE 112, which may be located in an enterprise (E); a UE 113, which may be located in a WiFi Hotspot (HS); a UE 114, which may be located in a first residence (R); a UE 115, which may be located in a second residence (R); a UE 116, which may be a mobile device (M), such as a cellular phone, a wireless laptop computer, a wireless PDA, etc. GNB 103 provides wireless broadband access to network 130 for a second plurality of UEs within a coverage area 125 of gNB 103. The second plurality of UEs include a UE 115 and a UE 116. In some embodiments, one or more of gNBs 101-103 can communicate with each other and with UEs 111-116 using 5G, Long Term Evolution (LTE), LTE-A, WiMAX or other advanced wireless communication technologies.

The dashed lines show approximate ranges of the coverage areas 120 and 125, and the ranges are shown as approximate circles merely for illustration and explanation purposes. It should be clearly understood that the coverage areas associated with the gNBs, such as the coverage areas 120 and 125, may have other shapes, including irregular shapes, depending on configurations of the gNBs and changes in the radio environment associated with natural obstacles and man-made obstacles.

As will be described in more detail below, one or more of gNB 101, gNB 102, and gNB 103 include a 2D antenna array as described in embodiments of the disclosure. In some embodiments, one or more of gNB 101, gNB 102, and gNB 103 support codebook designs and structures for systems with 2D antenna arrays.

Although FIG. 1 illustrates an example of the wireless network 100, various changes can be made to FIG. 1. The wireless network 100 can include any number of gNBs and any number of UEs in any suitable arrangement, for example. Furthermore, gNB 101 can directly communicate with any number of UEs and provide wireless broadband access to the network 130 for those UEs. Similarly, each gNB 102-103 can directly communicate with the network 130 and provide direct wireless broadband access to the network 130 for the UEs. In addition, gNB 101, 102 and/or 103 can provide access to other or additional external networks, such as external telephone networks or other types of data networks.

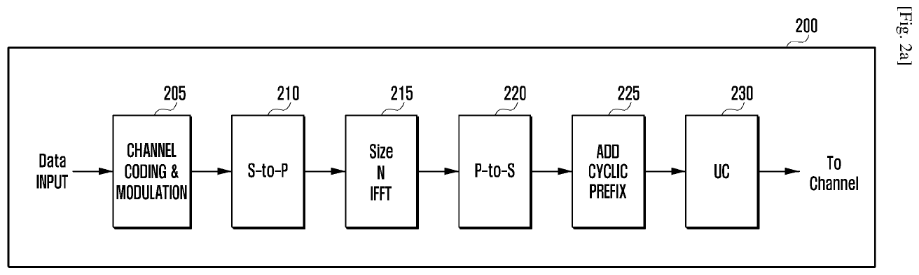

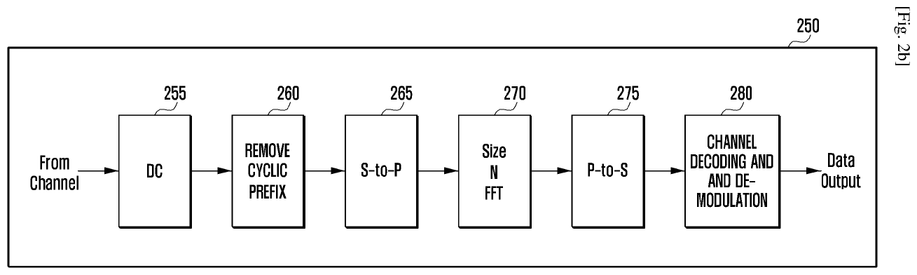

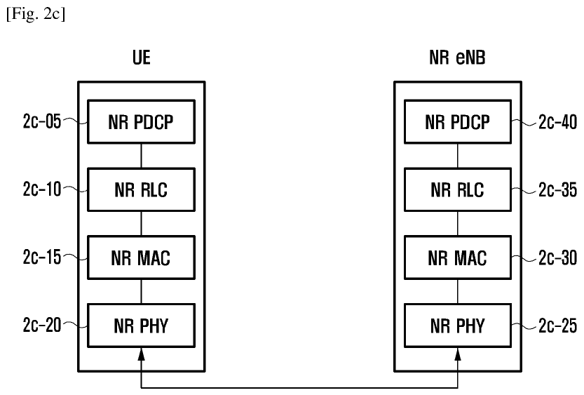

FIGS. 2A and 2B illustrate example wireless transmission and reception paths according to some embodiments of the disclosure. In the following description, the transmission path 200 can be described as being implemented in a gNB, such as gNB 102, and the reception path 250 can be described as being implemented in a UE, such as UE 116. However, it should be understood that the reception path 250 can be implemented in a gNB and the transmission path 200 can be implemented in a UE. In some embodiments, the reception path 250 is configured to support codebook designs and structures for systems with 2D antenna arrays as described in embodiments of the disclosure.

The transmission path 200 includes a channel coding and modulation block 205, a Serial-to-Parallel (S-to-P) block 210, a size N Inverse Fast Fourier Transform (IFFT) block 215, a Parallel-to-Serial (P-to-S) block 220, a cyclic prefix addition block 225, and an up-converter (UC) 230. The reception path 250 includes a down-converter (DC) 255, a cyclic prefix removal block 260, a Serial-to-Parallel (S-to-P) block 265, a size N Fast Fourier Transform (FFT) block 270, a Parallel-to-Serial (P-to-S) block 275, and a channel decoding and demodulation block 280.

In the transmission path 200, the channel coding and modulation block 205 receives a set of information bits, applies coding (such as Low Density Parity Check (LDPC) coding), and modulates the input bits (such as using Quadrature Phase Shift Keying (QPSK) or Quadrature Amplitude Modulation (QAM)) to generate a sequence of frequency-domain modulated symbols. The Serial-to-Parallel (S-to-P) block 210 converts (such as demultiplexes) serial modulated symbols into parallel data to generate N parallel symbol streams, where N is a size of the IFFT/FFT used in gNB 102 and UE 116. The size N IFFT block 215 performs IFFT operations on the N parallel symbol streams to generate a time domain output signal. The Parallel-to-Serial block 220 converts (such as multiplexes) parallel time domain output symbols from the Size N IFFT block 215 to generate a serial time domain signal. The cyclic prefix addition block 225 inserts a cyclic prefix into the time domain signal. The up-converter 230 modulates (such as up-converts) the output of the cyclic prefix addition block 225 to an RF frequency for transmission via a wireless channel. The signal can also be filtered at a baseband before switching to the RF frequency.

The RF signal transmitted from gNB 102 arrives at UE 116 after passing through the wireless channel, and operations in reverse to those at gNB 102 are performed at UE 116. The down-converter 255 down-converts the received signal to a baseband frequency, and the cyclic prefix removal block 260 removes the cyclic prefix to generate a serial time domain baseband signal. The Serial-to-Parallel block 265 converts the time domain baseband signal into a parallel time domain signal. The Size N FFT block 270 performs an FFT algorithm to generate N parallel frequency-domain signals. The Parallel-to-Serial block 275 converts the parallel frequency-domain signal into a sequence of modulated data symbols. The channel decoding and demodulation block 280 demodulates and decodes the modulated symbols to recover the original input data stream.

Each of gNBs 101-103 may implement a transmission path 200 similar to that for transmitting to UEs 111-116 in the downlink, and may implement a reception path 250 similar to that for receiving from UEs 111-116 in the uplink. Similarly, each of UEs 111-116 may implement a transmission path 200 for transmitting to gNBs 101-103 in the uplink, and may implement a reception path 250 for receiving from gNBs 101-103 in the downlink.

Each of the components in FIGS. 2A and 2B can be implemented using only hardware, or using a combination of hardware and software/firmware. As a specific example, at least some of the components in FIGS. 2A and 2B may be implemented in software, while other components may be implemented in configurable hardware or a combination of software and configurable hardware. For example, the FFT block 270 and IFFT block 215 may be implemented as configurable software algorithms, in which the value of the size N may be modified according to the implementation.

Furthermore, although described as using FFT and IFFT, this is only illustrative and should not be interpreted as limiting the scope of the disclosure. Other types of transforms can be used, such as Discrete Fourier transform (DFT) and Inverse Discrete Fourier Transform (IDFT) functions. It should be understood that for DFT and IDFT functions, the value of variable N may be any integer (such as 1, 2, 3, 4, etc.), while for FFT and IFFT functions, the value of variable N may be any integer which is a power of 2 (such as 1, 2, 4, 8, 16, etc.).

Although FIGS. 2A and 2B illustrate examples of wireless transmission and reception paths, various changes may be made to FIGS. 2A and 2B. For example, various components in FIGS. 2A and 2B can be combined, further subdivided or omitted, and additional components can be added according to specific requirements. Furthermore, FIGS. 2A and 2B are intended to illustrate examples of types of transmission and reception paths that can be used in a wireless network. Any other suitable architecture can be used to support wireless communication in a wireless network.

FIG. 2C illustrates a radio protocol architecture of a next generation mobile communication system according to an embodiment of the disclosure.

Referring to FIG. 2C, for each of a UE and a NR base station, the radio protocol of the next generation mobile communication system includes NR PDCPs 2c-05 and 2c-40, NR RLCs 2c-10 and 2c-35, and NR MACs 2c-15 and 2c-30. The main functions of the NR PDCPs 2c-05 and 2c-40 may include some of the following functions:
Header compression and decompression: ROHC only
Transmission of user data
In-sequence delivery of upper layer PDUs
Out-of-order delivery of upper layer PDUs
PDCP PDU reordering for reception
Duplicate detection of lower layer SDUs
Retransmission of PDCP SDUs
Ciphering and deciphering
Timer-based SDU discard in uplink

The reordering function of the NR PDCP device refers to a function of sequentially reordering PDCP PDUs, received from a lower layer based on a PDCP sequence number (SN), and may include a function of transmitting data to an upper layer in the sequence of reordering, a function of transmitting data without considering the sequence, a function of reordering the sequence and recording missing PDCP PDUs, a function of providing a state report on the missing PDCP PDUs to a transmitting side, and a function of requesting retransmission of the missing PDCP PDUs.

The main functions of the NR RLCs 2c-10 and 2c-35 may include some of the following functions:
Transfer of upper layer PDUs
In-sequence delivery of upper layer PDUs
Out-of-sequence delivery of upper layer PDUs
Error correction through ARQ
Concatenation, segmentation and reassembly of RLC SDUs
Re-segmentation of RLC data PDUs
Reordering of RLC data PDUs
Duplicate detection
Protocol error detection
RLC SDU discard
RLC re-establishment

The in-sequence delivery function of the NR RLC device refers to a function of transmitting RLC SDUs, received from a lower layer, to an upper layer in the sequence of reception, and may include: if one RLC SDU is originally segmented into multiple RLC SDUs and received, a function of reassembling and transmitting the multiple RLC SDUs; a function of reordering the received RLC PDUs based on an RLC sequence number (SN) or PDCP SN; a function of reordering the sequence and recording missing RLC PDUs; a function of providing a state report on the missing RLC PDUs to a transmitting side; and a function of requesting retransmission of the missing RLC PDUs.

The out-of-sequence delivery function of the NR RLC device refers to a function of directly transmitting RLC SDUs, received from a lower layer, to an upper layer regardless of the order, and may include, if one RLC SDU has been originally segmented into multiple RLC SDUs and received, a function of reassembling the multiple RLC SDUs and transmitting the same; and a function of storing the RLC SNs or PDCP SNs of the received RLC PDUs, reordering the sequence, and recording missing RLC PDUs.

The NR MACs 2c-15 and 2c-30 may be connected to multiple NR RLC layer devices configured in a UE, and the main functions of the NR MAC may include some of the following functions:
Mapping between logical channels and transmission channels
Multiplexing/demultiplexing of MAC SDUs
Scheduling information report
Error correction through HARQ
Priority handling between logical channels of a UE
Priority handling between UEs by means of dynamic scheduling.
MBMS service identification
Transmission format selection
Padding

The NR physical (PHY) layers 2c-20 and 2c-25 may perform operations of channel coding and modulating upper layer data, generating the upper layer data into an OFDM symbols transmitting the OFDM symbol via a radio channel, or demodulating and channel decoding the OFDM symbol received via the radio channel, and transferring the OFDM symbol to an upper layer.

In the disclosure, a transmitting end device may be a base station or UE and a reception end device may be a base station or UE. That is, the disclosure may include both a case where the transmitting end device is a base station and the reception end device is a UE (downlink data transmission scenario) or a case where the transmitting end device is a UE and the reception end device is a base station (uplink data transmission scenario).

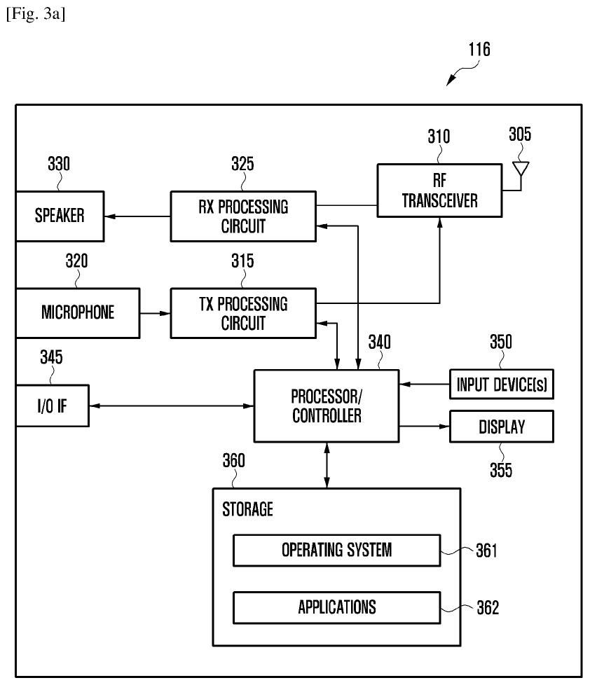

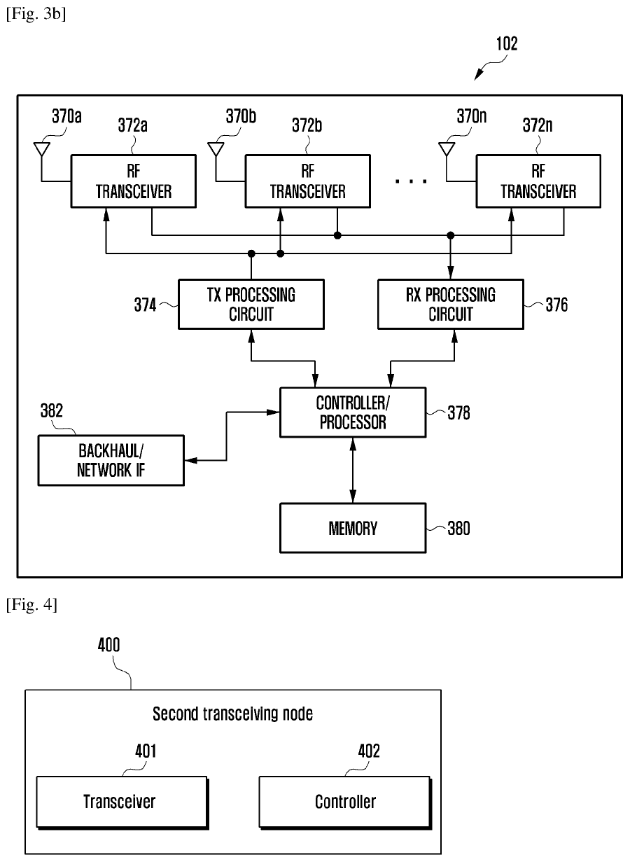

FIG. 3A illustrates an example UE 116 according to the disclosure. The embodiment of UE 116 shown in FIG. 3A is for illustration only, and UEs 111-115 of FIG. 1 can have the same or similar configuration. However, a UE has various configurations, and FIG. 3A does not limit the scope of the disclosure to any specific implementation of the UE.

UE 116 includes an antenna 305, a radio frequency (RF) transceiver 310, a transmission (TX) processing circuit 315, a microphone 320, and a reception (RX) processing circuit 325. UE 116 also includes a speaker 330, a processor/controller 340, an input/output (I/O) interface 345, an input device(s) 350, a display 355, and a memory 360. The memory 360 includes an operating system (OS) 361 and one or more applications 362.

The RF transceiver 310 receives an incoming RF signal transmitted by a gNB of the wireless network 100 from the antenna 305. The RF transceiver 310 down-converts the incoming RF signal to generate an intermediate frequency (IF) or baseband signal. The IF or baseband signal is transmitted to the RX processing circuit 325, where the RX processing circuit 325 generates a processed baseband signal by filtering, decoding and/or digitizing the baseband or IF signal. The RX processing circuit 325 transmits the processed baseband signal to speaker 330 (such as for voice data) or to processor/ controller 340 for further processing (such as for web browsing data).

The TX processing circuit 315 receives analog or digital voice data from microphone 320 or other outgoing baseband data (such as network data, email or interactive video game data) from processor/controller 340. The TX processing circuit 315 encodes, multiplexes, and/or digitizes the outgoing baseband data to generate a processed baseband or IF signal. The RF transceiver 310 receives the outgoing processed baseband or IF signal from the TX processing circuit 315 and up-converts the baseband or IF signal into an RF signal transmitted via the antenna 305.

The processor/controller 340 can include one or more processors or other processing devices and execute an OS 361 stored in the memory 360 in order to control the overall operation of UE 116. For example, the processor/controller 340 can control the reception of forward channel signals and the transmission of backward channel signals through the RF transceiver 310, the RX processing circuit 325 and the TX processing circuit 315 according to well-known principles. In some embodiments, the processor/ controller 340 includes at least one microprocessor or microcontroller.

The processor/controller 340 is also capable of executing other processes and programs residing in the memory 360, such as operations for channel quality measurement and reporting for systems with 2D antenna arrays as described in embodiments of the disclosure. The processor/controller 340 can move data into or out of the memory 360 as required by an execution process. In some embodiments, the processor/controller 340 is configured to execute the application 362 based on the OS 361 or in response to signals received from the gNB or the operator. The processor/ controller 340 is also coupled to an I/O interface 345, where the I/O interface 345 provides UE 116 with the ability to connect to other devices such as laptop computers and handheld computers. I/O interface 345 is a communication path between these accessories and the processor/controller 340.

The processor/controller 340 is also coupled to the input device(s) 350 and the display 355. An operator of UE 116 can input data into UE 116 using the input device(s) 350. The display 355 may be a liquid crystal display or other display capable of presenting text and/or at least limited graphics (such as from a website). The memory 360 is coupled to the processor/controller 340. A part of the memory 360 can include a random access memory (RAM), while another part of the memory 360 can include a flash memory or other read-only memory (ROM).

Although FIG. 3A illustrates an example of UE 116, various changes can be made to FIG. 3A. For example, various components in FIG. 3A can be combined, further subdivided or omitted, and additional components can be added according to specific requirements. As a specific example, the processor/controller 340 can be divided into a plurality of processors, such as one or more central processing units (CPUs) and one or more graphics processing units (GPUs). Furthermore, although FIG. 3A illustrates that the UE 116 is configured as a mobile phone or a smart phone, UEs can be configured to operate as other types of mobile or fixed devices.

FIG. 3B illustrates an example gNB 102 according to some embodiments of the disclosure. The embodiment of gNB 102 shown in FIG. 3B is for illustration only, and other gNBs of FIG. 1 can have the same or similar configuration. However, a gNB has various configurations, and FIG. 3B does not limit the scope of the disclosure to any specific implementation of a gNB. It should be noted that gNB 101 and gNB 103 can include the same or similar structures as gNB 102.

As shown in FIG. 3B, gNB 102 includes a plurality of antennas 370a-370n, a plurality of RF transceivers 372a-372n, a transmission (TX) processing circuit 374, and a reception (RX) processing circuit 376. In certain embodiments, one or more of the plurality of antennas 370 a-370n include a 2D antenna array. gNB 102 also includes a controller/processor 378, a memory 380, and a backhaul or network interface 382.

RF transceivers 372a-372n receive an incoming RF signal from antennas 370a-370n, such as a signal transmitted by UEs or other gNBs. RF transceivers 372a-372n down-convert the incoming RF signal to generate an IF or baseband signal. The IF or baseband signal is transmitted to the RX processing circuit 376, where the RX processing circuit 376 generates a processed baseband signal by filtering, decoding and/or digitizing the baseband or IF signal. RX processing circuit 376 transmits the processed baseband signal to controller/processor 378 for further processing.

The TX processing circuit 374 receives analog or digital data (such as voice data, network data, email or interactive video game data) from the controller/processor 378. TX processing circuit 374 encodes, multiplexes and/or digitizes outgoing baseband data to generate a processed baseband or IF signal. RF transceivers 372a-372n receive the outgoing processed baseband or IF signal from TX processing circuit 374 and up-convert the baseband or IF signal into an RF signal transmitted via antennas 370a-370n.

The controller/processor 378 can include one or more processors or other processing devices that control the overall operation of gNB 102. For example, the controller/processor 378 can control the reception of forward channel signals and the transmission of backward channel signals through the RF transceivers 372a-372n, the RX processing circuit 376 and the TX processing circuit 374 according to well-known principles. The controller/processor 378 can also support additional functions, such as higher-level wireless communication functions. For example, the controller/processor 378 can perform a Blind Interference Sensing (BIS) process such as that performed through a BIS algorithm, and decode a received signal from which an interference signal is subtracted. A controller/processor 378 may support any of a variety of other functions in gNB 102. In some embodiments, the controller/processor 378 includes at least one microprocessor or microcontroller.

The controller/processor 378 is also capable of executing programs and other processes residing in the memory 380, such as a basic OS. The controller/processor 378 can also support channel quality measurement and reporting for systems with 2D antenna arrays as described in embodiments of the disclosure. In some embodiments, the controller/processor 378 supports communication between entities such as web RTCs. The controller/processor 378 can move data into or out of the memory 380 as required by an execution process.

The controller/processor 378 is also coupled to the backhaul or network interface 382. The backhaul or network interface 382 allows gNB 102 to communicate with other devices or systems through a backhaul connection or through a network. The backhaul or network interface 382 can support communication over any suitable wired or wireless connection(s). For example, when gNB 102 is implemented as a part of a cellular communication system, such as a cellular communication system supporting 5G or new radio access technology or NR, LTE or LTE-A, the backhaul or network interface 382 can allow gNB 102 to communicate with other gNBs through wired or wireless backhaul connections. When gNB 102 is implemented as an access point, the backhaul or network interface 382 can allow gNB 102 to communicate with a larger network, such as the Internet, through a wired or wireless local area network or through a wired or wireless connection. The backhaul or network interface 382 includes any suitable structure that supports communication through a wired or wireless connection, such as an Ethernet or an RF transceiver.

The memory 380 is coupled to the controller/processor 378. A part of the memory 380 can include an RAM, while another part of the memory 380 can include a flash memory or other ROMs. In certain embodiments, a plurality of instructions, such as the BIS algorithm, are stored in the memory. The plurality of instructions are configured to cause the controller/processor 378 to execute the BIS process and decode the received signal after subtracting at least one interference signal determined by the BIS algorithm.

As will be described in more detail below, the transmission and reception paths of gNB 102 (implemented using RF transceivers 372a-372n, TX processing circuit 374 and/or RX processing circuit 376) support aggregated communication with FDD cells and TDD cells.

Although FIG. 3B illustrates an example of gNB 102, various changes may be made to FIG. 3B. For example, gNB 102 can include any number of each component shown in FIG. 3A. As a specific example, the access point can include many backhaul or network interfaces 382, and the controller/processor 378 can support routing functions to route data between different network addresses. As another specific example, although shown as including a single instance of the TX processing circuit 374 and a single instance of the RX processing circuit 376, gNB 102 can include multiple instances of each (such as one for each RF transceiver).

Those skilled in the art will understand that, “terminal” and “terminal device” as used herein include not only devices with wireless signal receiver which have no transmitting capability, but also devices with receiving and transmitting hardware which can carry out bidirectional communication on a bidirectional communication link. Such devices may include cellular or other communication devices with single-line displays or multi-line displays or cellular or other communication devices without multi-line displays; a PCS (personal communications service), which may combine voice, data processing, fax and/or data communication capabilities; a PDA (Personal Digital Assistant), which may include a radio frequency receiver, a pager, an internet/ intranet access, a web browser, a notepad, a calendar and/or a GPS (Global Positioning System) receiver; a conventional laptop and/or palmtop computer or other devices having and/or including a radio frequency receiver. “Terminal” and “terminal device” as used herein may be portable, transportable, installed in vehicles (aviation, sea transportation and/or land), or suitable and/or configured to operate locally, and/or in distributed form, operate on the earth and/or any other position in space. “Terminal” and “terminal device” as used herein may also be a communication terminal, an internet terminal, a music/video playing terminal, such as a PDA, a MID (Mobile Internet Device) and/or a mobile phone with music/video playing functions, a smart TV, a set-top box and other devices.

With the rapid development of information industry, especially the increasing demand from mobile Internet and internet of things (IoT), it brings unprecedented challenges to the future mobile communication technology. In order to meet the unprecedented challenges, the communication industry and academia have carried out extensive research on the fifth generation (5G) mobile communication technology to face the 2020s. At present in ITU report ITU-R M.[IMT.VISION], the framework and overall goals of the future 5G has been discussed, in which the demand outlook, application scenarios and important performance indicators of 5G are described in detail. With respect to new requirements in 5G, ITU report ITU-R M.[IMT.FUTURE TECHNOLOGY TRENDS] provides information related to the technology trends of 5G, aiming at solving significant problems such as significantly improved system throughput, consistent user experience, scalability to support IoT, delay, energy efficiency, cost, network flexibility, support of emerging services and flexible spectrum utilization. In 3GPP (3rd Generation Partnership Project), the first stage of 5G is already in progress. To support more flexible scheduling, the 3GPP decides to support variable Hybrid Automatic Repeat request-Acknowledgement (HARQ-ACK) feedback delay in 5G. In existing Long Term Evolution (LTE) systems, a time from reception of downlink data to uplink transmission of HARQ-ACK is fixed. For example, in Frequency Division Duplex (FDD) systems, the delay is 4 subframes. In Time Division Duplex (TDD) systems, a HARQ-ACK feedback delay is determined for a corresponding downlink subframe based on an uplink and downlink configuration. In 5G systems, whether FDD or TDD systems, for a determined downlink time unit (e.g., a downlink slot or a downlink mini slot), the uplink time unit that can feedback HARQ-ACK is variable. For example, the delay of HARQ-ACK feedback can be dynamically indicated by physical layer signaling, or different HARQ-ACK delays can be determined based on factors such as different services or user capabilities.

The 3GPP has defined three directions of 5G application scenarios-eMBB (enhanced mobile broadband), mMTC (massive machine-type communication) and URLLC (ultra-reliable and low-latency communication). The eMBB scenario aims to further improve data transmission rate on the basis of the existing mobile broadband service scenario, so as to enhance user experience and pursue ultimate communication experience between people. mMTC and URLLC are, for example, the application scenarios of the Internet of Things, but their respective emphases are different: mMTC being mainly information interaction between people and things, while URLLC mainly reflecting communication requirements between things.

Data transmission needs to satisfy a certain latency requirement. If the delay of a packet exceeds the latency requirement, the transmission of the packet is invalid. In wireless networks, transmission of invalid packets will waste radio resources, and thus reducing the spectrum efficiency of the system. Therefore, how to improve the spectrum efficiency of the system and how to ensure that the data transmission satisfies the latency requirement need to be solved.

In order to solve at least the above technical problems, embodiments of the disclosure provide a method performed by a terminal, the terminal, a method performed by a base station and the base station in a wireless communication system, and a non-transitory computer-readable storage medium. Hereinafter, various embodiments of the disclosure will be described in detail with reference to the accompanying drawings.

In embodiments of the disclosure, for the convenience of description, a first transceiving node and a second transceiving node are defined. For example, the first transceiving node may be a base station, and the second transceiving node may be a UE. In the following examples, the base station is taken as an example (but not limited thereto) to illustrate the first transceiving node, and the UE is taken as an example (but not limited thereto) to illustrate the second transceiving node.

Exemplary embodiments of the disclosure are further described below with reference to the drawings.

The text and drawings are provided as examples only to help readers understand the disclosure. They are not intended and should not be interpreted as limiting the scope of the disclosure in any way. Although certain embodiments and examples have been provided, based on the content disclosed herein, it will be apparent to those skilled in the art that changes may be made to the illustrated embodiments and examples without departing from the scope of the disclosure.

FIG. 4 illustrates a block diagram of the second transceiving node according to an embodiment of the disclosure.

Referring to FIG. 4, the second transceiving node 400 may include a transceiver 401 and a controller 402.

The transceiver 401 may be configured to receive first data and/or first control signaling from the first transceiving node, and transmit second data and/or second control signaling to the first transceiving node in a determined time unit.

The controller 402 may be an application specific integrated circuit or at least one processor. The controller 402 may be configured to control the overall operation of the second transceiving node and control the second transceiving node to implement the methods proposed in the embodiments of the disclosure. For example, the controller 402 may be configured to determine the second data and/or the second control signaling and a time unit for transmitting the second data and/or the second control signaling based on the first data and/or the first control signaling, and control the transceiver 401 to transmit the second data and/or the second control signaling to the first transceiving node in the determined time unit.

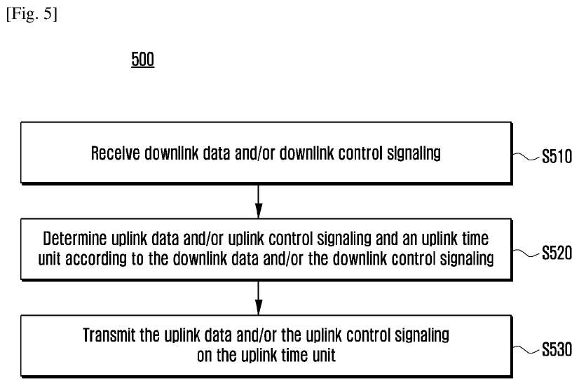

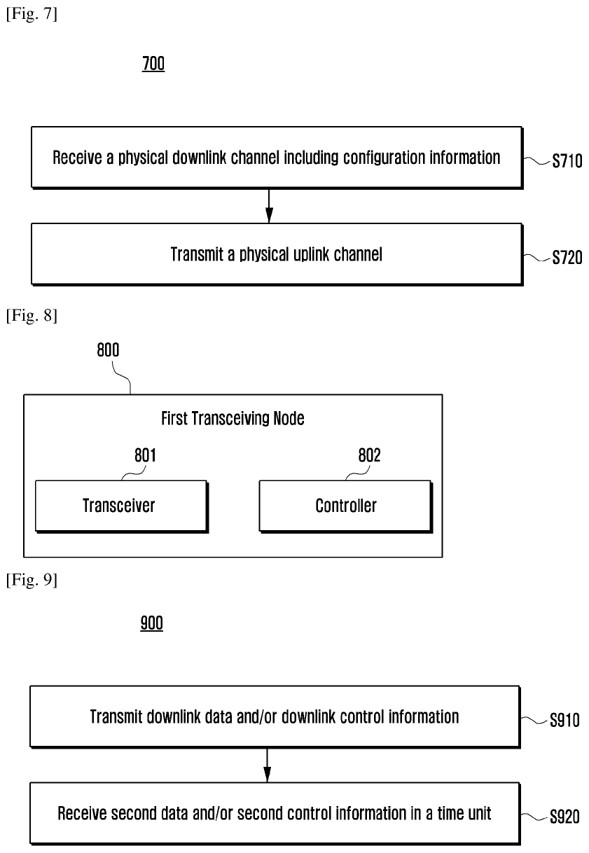

In some implementations, the controller 402 may be configured to perform one or more of operations in methods of various embodiments described below. For example, the controller 402 may be configured to perform one or more of operations in a method 500 to be described in connection with FIG. 5, in a method 700 to be described in connection with FIG. 7 later and/or that described according to various embodiments of the disclosure (e.g., in manners MN1-MN6).

In some implementations, the first data may be data transmitted by the first transceiving node to the second transceiving node. In the following examples, downlink data carried by a PDSCH (Physical Downlink Shared Channel) is taken as an example (but not limited thereto) to illustrate the first data.

In some implementations, the second data may be data transmitted by the second transceiving node to the first transceiving node. In the following examples, uplink data carried by a PUSCH (Physical Uplink Shared Channel) is taken as an example to illustrate the second data, but not limited thereto.

In some implementations, the first control signaling may be control signaling transmitted by the first transceiving node to the second transceiving node. In the following examples, downlink control signaling is taken as an example (but not limited thereto) to illustrate the first control signaling. The downlink control signaling may be DCI (downlink control information) carried by a PDCCH (Physical Downlink Control Channel) and/or control signaling carried by a PDSCH (Physical Downlink Shared Channel). For example, the DCI may be UE specific DCI, and the DCI may also be common DCI. The common DCI may be DCI common to a part of UEs, such as group common DCI, and the common DCI may also be DCI common to all of the UEs. The DCI may be uplink DCI (e.g., DCI for scheduling a PUSCH) and/or downlink DCI (e.g., DCI for scheduling a PDSCH).

In some implementations, the second control signaling may be control signaling transmitted by the second transceiving node to the first transceiving node. In the following examples, uplink control signaling is taken as an example (but is not limited thereto) to illustrate the second control signaling. The uplink control signaling may be UCI (Uplink Control Information) carried by a PUCCH (Physical Uplink Control Channel) and/or control signaling carried by a PUSCH (Physical Uplink Shared Channel). A type of UCI may include one or more of: HARQ-ACK information, SR (Scheduling Request), LRR (Link Recovery Request), CSI (Chanel State Information) or CG (Configured Grant) UCI. In embodiments of the disclosure, when UCI is carried by a PUCCH, the UCI may be used interchangeably with the PUCCH.

In some implementations, a PUCCH with SR may be a PUCCH with positive SR and/or negative SR. SR may be positive SR and/or negative SR.

In some implementations, the CSI may also be Part 1 CSI and/or Part 2 CSI.

In some implementations, a first time unit is a time unit in which the first transceiving node transmits the first data and/or the first control signaling. In the following examples, a downlink time unit is taken as an example (but not limited thereto) to illustrate the first time unit.

In some implementations, a second time unit is a time unit in which the second transceiving node transmits the second data and/or the second control signaling. In the following examples, an uplink time unit is taken as an example (but not limited thereto) to illustrate the second time unit.

In some implementations, the first time unit and the second time unit may be one or more slots, one or more subslots, one or more OFDM symbols, or one or more subframes.

Herein, depending on the network type, the term “base station” or “BS” can refer to any component (or a set of components) configured to provide wireless access to a network, such as a Transmission Point (TP), a Transmission and Reception Point (TRP), an evolved base station (eNodeB or eNB), a 5G base station (gNB), a macrocell, a femtocell, a WiFi access point (AP), or other wirelessly enabled devices. Base stations may provide wireless access in accordance with one or more wireless communication protocols, e.g., 5G 3GPP new radio (NR) interface/access, Long Term Evolution (LTE), LTE advanced (LTE-A), High Speed Packet Access (HSPA), Wi-Fi 802.11a/b/g/n/ac, etc.

In describing a wireless communication system and in the disclosure described below, higher layer signaling or higher layer signals may be signal transferring methods for transferring information from a base station to a terminal over a downlink data channel of a physical layer or from a terminal to a base station over an uplink data channel of a physical layer, and examples of the signal transferring methods may include signal transferring methods for transferring information via Radio Resource Control (RRC) signaling, Packet Data Convergence Protocol (PDCP) signaling, or a Medium Access Control (MAC) Control Element (MAC CE).

FIG. 5 illustrates a flowchart of a method performed by a UE according to embodiments of the disclosure.

Referring to FIG. 5, in step S510, the UE may receive downlink data (e.g., downlink data carried by a PDSCH) and/or downlink control signaling from a base station. For example, the UE may receive the downlink data and/or the downlink control signaling from the base station based on predefined rules and/or received configuration parameters.

In step S520, the UE determines uplink data and/or uplink control signaling and an uplink time unit based on the downlink data and/or downlink control signaling.

In step S530, the UE transmits the uplink data and/or the uplink control signaling to the base station in an uplink time unit.

In some implementations, steps S520 and/or S530 may be performed based on methods described according to various embodiments of the disclosure (e.g., in manners MN1-MN6).

In some implementations, the methods may omit some steps or include additional steps, such as operations performed by a terminal (e.g., UE) according to various embodiments of the disclosure (e.g., in manners MN1-MN6).

In some implementations, acknowledgement/negative acknowledgement (ACK/NACK) for downlink transmissions may be performed through HARQ-ACK.

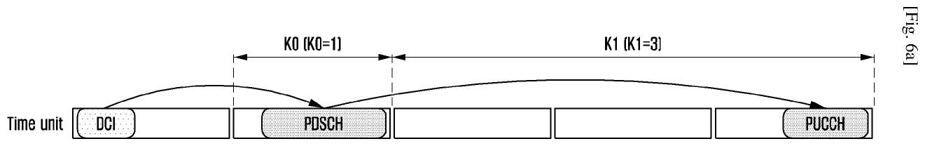

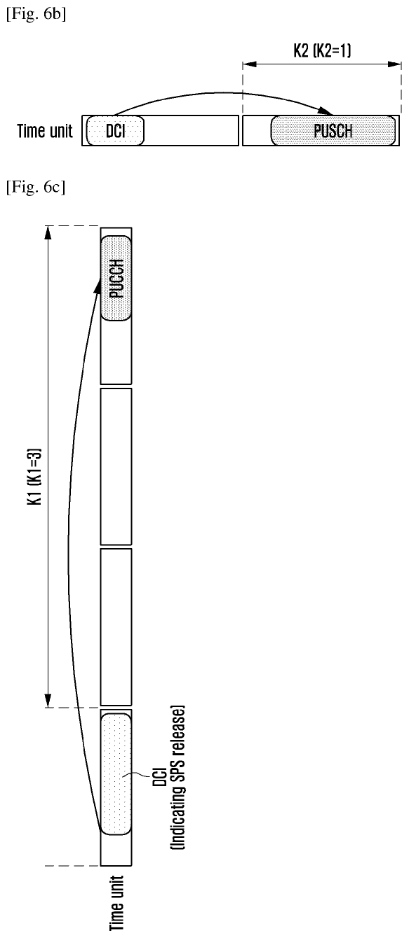

In some implementations, the downlink control signaling may include DCI carried by a PDCCH and/or control signaling carried by a PDSCH. For example, the DCI may be used to schedule transmission of a PUSCH or reception of a PDSCH. Some examples of uplink transmission timing will be described below with reference to FIGS. 6A-6C.

In an example, the UE receives the DCI and receives the PDSCH based on time domain resources indicated by the DCI. For example, a parameter K0 may be used to represent a time interval between the PDSCH scheduled by the DCI and the PDCCH carrying the DCI, and K0 may be in units of slots. For example, FIG. 6A gives an example in which K0=1. In the example illustrated in FIG. 6A, the time interval from the PDSCH scheduled by the DCI to the PDCCH carrying the DCI is one slot. In embodiments of the disclosure, “a UE receives DCI” may mean that “the UE detects the DCI”.

In another example, the UE receives the DCI and transmits the PUSCH based on time domain resources indicated by the DCI. For example, a timing parameter K2 may be used to represent a time interval between the PUSCH scheduled by the DCI and the PDCCH carrying the DCI, and K2 may be in units of slots. For example, FIG. 6B gives an example in which K2=1. In the example illustrated in FIG. 6B, the time interval between the PUSCH scheduled by the DCI and the PDCCH carrying the DCI is one slot. K2 may also represent a time interval between a PDCCH for activating a CG (configured grant) PUSCH and the first activated CG PUSCH. In examples of the disclosure, unless otherwise specified, the PUSCH may be a dynamically scheduled PUSCH (e.g., scheduled by DCI) (e.g., may be referred to as DG (dynamic grant) PUSCH, in embodiments of the disclosure) and/or a PUSCH not scheduled by DCI (e.g., CG PUSCH).

In yet another example, the UE receives the PDSCH, and may transmit HARQ-ACK information for the PDSCH reception in a PUCCH in the uplink time unit. For example, a timing parameter (which may also be referred to as a timing value) K1 (e.g., the parameter dl-DataToUL-ACK in 3GPP) may be used to represent a time interval between the PUCCH for transmitting the HARQ-ACK information for the PDSCH reception and the PDSCH, and K1 may be in units of uplink time units, such as slots or subslots. In a case where K1 is in units of slots, the time interval is a value of a slot offset between the PUCCH for feeding back the HARQ-ACK information for the PDSCH reception and the PDSCH, and K1 may be referred to as a slot timing value. For example, FIG. 6A gives an example in which K1=3. In the example illustrated in FIG. 6A, the time interval between the PUCCH for transmitting the HARQ-ACK information for the PDSCH reception and the PDSCH reception is 3 slots. It should be noted that in embodiments of the disclosure, the timing parameter K1 may be used interchangeably with a timing parameter K1, the timing parameter K0 may be used interchangeably with a timing parameter K₀, and the timing parameter K2 may be used interchangeably with a timing parameter K₂.

The PDSCH may be a PDSCH scheduled by the DCI and/or a SPS PDSCH. The UE will periodically receive the SPS PDSCH after the SPS PDSCH is activated by the DCI. In examples of the disclosure, the SPS PDSCH may be equivalent to a PDSCH not scheduled by the DCI/PDCCH. After the SPS PDSCH is released (deactivated), the UE will no longer receive the SPS PDSCH.

In embodiments of the disclosure, HARQ-ACK may be HARQ-ACK for a SPS PDSCH reception (e.g., HARQ-ACK not indicated by DCI) and/or HARQ-ACK indicated by a DCI format (e.g., HARQ-ACK for a PDSCH reception scheduled by a DCI format).

In yet another example, the UE receives the DCI (e.g., DCI indicating SPS (Semi-Persistent Scheduling) PDSCH release (deactivation)), and may transmit HARQ-ACK information for the DCI in the PUCCH in the uplink time unit. For example, the timing parameter K1 may be used to represent a time interval between the PUCCH for transmitting the HARQ-ACK information for the DCI and the DCI, and K1 may be in units of uplink time units, such as slots or subslots. For example, FIG. 6C gives an example in which K1=3. In the example of FIG. 6C, the time interval between the PUCCH for transmitting the HARQ-ACK information for the DCI and the DCI is 3 slots. For example, the timing parameter K1 may be used to represent a time interval between a PDCCH reception with DCI indicating SPS PDSCH release (deactivation) and the PUCCH feeding back HARQ-ACK for the PDCCH reception.

In some implementations, in step S520, the UE may report (or signal/transmit) a UE capability to the base station or indicate the UE capability. For example, the UE reports (or signals/transmits) the UE capability to the base station by transmitting the PUSCH. In this case, the UE capability information is included in the PUSCH transmitted by the UE.

In some implementations, the base station may configure higher layer signaling for the UE based on a UE capability previously received from the UE (e.g., in step S510 in the previous downlink-uplink transmission processes). For example, the base station configures the higher layer signaling for the UE by transmitting the PDSCH. In this case, the higher layer signaling configured for the UE is included in the PDSCH transmitted by the base station. It should be noted that the higher layer signaling is higher layer signaling compared with physical layer signaling, and the higher layer signaling may include RRC signaling and/or a MAC CE.

In some implementations, downlink channels (downlink resources) may include PDCCHS And/or PDSCHS. Uplink channels (uplink resources) may include PUCCHS and/or PUSCHs.

In some implementations, the UE may be configured with two levels of priorities for uplink transmission. For example, the UE may be configured to multiplex UCIs with different priorities via higher layer signaling (e.g., through the 3GPP parameter UCI-Mux WithDifferentPriority); otherwise (e.g., if the UE is not configured to multiplex UCIs with different priorities), the UE performs prioritization for PUCCHs and/or PUSCHs with different priorities. For example, the two levels of priorities may include a first priority and a second priority which are different from each other. In an example, the first priority may be higher than the second priority, that is, the first priority is the higher priority, and the second priority is the lower priority. In another example, the first priority may be lower than the second priority. However, embodiments of the disclosure are not limited to this, and for example, the UE may be configured with more than two levels of priorities. For the sake of convenience, in embodiments of the disclosure, description will be made considering that the first priority is higher than the second priority. It should be noted that all embodiments of the disclosure are applicable to situations where the first priority may be higher than the second priority; all embodiments of the disclosure are applicable to situations where the first priority may be lower than the second priority; and all embodiments of the disclosure are applicable to situations where the first priority may be equal to the second priority.

For example, multiplexing multiple PUCCHs and/or PUSCHs that overlap in time domain may include multiplexing UCI information included in the PUCCHs in a PUCCH or PUSCH.

For example, prioritizing two PUCCHs and/or PUSCHs that overlap in time domain by the UE may include that the UE transmits a PUCCH or PUSCH of a higher priority, and/or that the UE does not transmit a PUCCH or PUSCH of a lower priority.

In embodiments of the disclosure, unicast may refer to a manner in which a network communicates with a UE, and multicast (or groupcast) may refer to a manner in which a network communicates with multiple UEs. For example, a unicast PDSCH may be a PDSCH received by a UE, and the scrambling of the PDSCH may be based on a Radio Network Temporary Identifier (RNTI) specific to the UE, e.g., Cell-RNTI (C-RNTI). A multicast PDSCH may be a PDSCH received by more than one UE simultaneously, and the scrambling of the multicast PDSCH may be based on a UE-group common RNTI. For example, the UE-group common RNTI for scrambling the multicast PDSCH may include an RNTI (referred to as G-RNTI in embodiments of the disclosure) for scrambling of a dynamically scheduled multicast transmission (e.g., PDSCH) or an RNTI (referred to as G-CS-RNTI in embodiments of the disclosure) for scrambling of a multicast SPS transmission (e.g., SPS PDSCH). The G-CS-RNTI and the G-RNTI may be different RNTIs or same RNTI. UCI(s) of the unicast PDSCH may include HARQ-ACK information, SR, or CSI of the unicast PDSCH reception. UCI(s) of the multicast (or groupcast) PDSCH may include HARQ-ACK information for the multicast PDSCH reception. In embodiments of the disclosure, “multicast” may also be replaced with “broadcast”

It should be noted that, unless the context clearly indicates otherwise, all or one or more of the methods, steps or operations described in embodiments of the disclosure may be specified by protocols and/or configured by higher layer signaling and/or indicated by dynamic signaling. The dynamic signaling may be PDCCH and/or DCI and/or DCI format. For example, SPS PDSCH and/or CG PUSCH may be dynamically indicated in corresponding activated DCI/DCI format/PDCCH. All or one or more of the described methods, steps and operations may be optional. For example, if a certain parameter (e.g., parameter X) is configured, the UE performs a certain approach (e.g., approach A), otherwise (if the parameter, e.g., parameter X, is not configured), the UE performs another approach (e.g., approach B).

It should be noted that, in embodiments of the disclosure, “‘A’ overlaps with ‘B’” may mean that ‘A’ at least partially overlaps with ‘B’. That is, “‘A’ overlaps with ‘B’” includes a case where ‘A’ completely overlaps with ‘B’. “‘A’ overlaps with ‘B’” may mean that ‘A’ overlaps with ‘B’ in time domain and/or ‘A’ overlaps with ‘B’ in frequency domain.

It should be noted that, a PCell (Primary Cell) or PSCell (Primary Secondary Cell) in embodiments of the disclosure may be used interchangeably with a cell having a PUCCH.

It should be noted that, methods for downlink in embodiments of the disclosure may also be applicable to uplink, and methods for uplink may also be applicable to downlink. For example, a PDSCH may be replaced with a PUSCH, a SPS PDSCH may be replaced with a CG PUSCH, and downlink symbols may be replaced with uplink symbols, so that methods for downlink may be applicable to uplink.

It should be noted that in methods of the disclosure, “configured and/or indicated with a transmission with repetitions” may be understood that the number of the repetitions of the transmission is greater than 1. For example, “configured and/or indicated with a transmission with repetitions” may be replaced with “PUCCH repeatedly transmitted on more than one slot/sub-slot”. “Not configured and/or indicated with a transmission with repetitions” may be understood that the number of the repetitions of the transmission equals to 1. For example, “PUCCH that is not configured and/or indicated with repetitions” may be replaced by “PUCCH transmission with the number of the repetitions of 1”. For example, the UE may be configured with a parameter

$${N}_{PUCCH}^{repeat}$$

is greater than 1, it may mean that the UE is configured with a PUCCH transmission with repetitions, and the UE may repeat the PUCCH transmission on

$${N}_{PUCCH}^{repeat}$$

time units (e.g., slots); when the parameter is equal to 1, it may mean that the UE is not configured with a PUCCH transmission with repetitions. For example, the repeatedly transmitted PUCCH may include only one type of UCI. If the PUCCH is configured with repetitions, in embodiments of the disclosure, a repetition of the multiple repetitions of the PUCCH may be used as a PUCCH (or a PUCCH resource), or all of the repetitions of the PUCCH may be used as a PUCCH (or a PUCCH resource), or a specific repetition of the multiple repetitions of the PUCCH may be used as a PUCCH (or a PUCCH resource).

It should be noted that, in methods of the disclosure, a PDCCH and/or DCI and/or a DCI format schedules multiple PDSCHs/PUSCHs, which may be multiple PDSCHs/ PUSCHs on a same serving cell and/or multiple PDSCHs/PUSCHs on different serving cells.

It should be noted that the multiple manners described in the disclosure may be combined in any order. In a combination, a manner may be performed one or more times.

It should be noted that, steps of methods of the disclosure may be implemented in any order.

It should be noted that, in methods of the disclosure, “canceling a transmission” may mean canceling the transmission of the entire uplink channel and/or cancelling the transmission of a part of the uplink channel.

It should be noted that, in methods of the disclosure, “an order from small to large” (e.g., an ascending order) may be replaced by “an order from large to small” (e.g., a descending order), and/or “an order from large to small” (e.g., a descending order) may be replaced by “an order from small to large” (e.g., an ascending order).

It should be noted that, in methods of the disclosure, a PUCCH/PUSCH carrying/ with A may be understood as a PUCCH/PUSCH carrying/with only A, and may also be understood as a PUCCH/PUSCH carrying/with at least A.

It should be noted that “slot” may be replaced by “subslot” or “time unit” in embodiments of the disclosure.

It should be noted that, in embodiments of the disclosure, “a predefined method (or step) is performed if a predefined condition is satisfied” and “a predefined method (or step) is not performed if a predefined condition is not satisfied” may be used interchangeably. “A predefined method (or step) is not performed if a predefined condition is satisfied” and “a predefined method (or step) is performed if a predefined condition is not satisfied” may be used interchangeably.

In an access network, the delay of a packet (for example, from a time that the packet arrives at a transmitting end to a time that it is successfully transferred to a receiving end) may need to satisfy a certain latency requirement. For example, the latency requirement may be defined as a PDB (packet delay budget). The PDB may be a limited time budget for a packet to be successfully transmitted from the transmitting end to the receiving end, for example. As an example, if the delay of the packet is larger than a given PDB for the packet, the packet is considered as violating PDB, otherwise the packet is considered as being delivered successfully. The value of the PDB may be different for different applications and service types.

For uplink transmission, that is, when the transmitting end is a UE and the receiving end is a base station, if the base station does not know the latency requirement (for example, PDB) for the packet, it may still schedule uplink transmission when the uplink transmission of the packet does not satisfy the latency requirement (for example, the actual transmission delay is larger than the PDB). For example, in order to at least solve this technical problem, one or more of the manners described below may be adopted.

### Manner MN1

According to embodiments of manner MN1, the UE may transmit first information related to a latency requirement (e.g., PDB) to the base station. As an example, the base station may transmit first configuration information used to indicate the UE to report the first information related to the latency requirement (e.g., PDB) to the UE.

For example, the UE may receive a first parameter (e.g., a first parameter configured by higher layer signaling) which may indicate the UE to report the first information related to the latency requirement (e.g., PDB). In this way, invalid scheduling by the base station may be reduced, for example, uplink transmission (e.g., PUSCH) exceeding the latency requirement (e.g., PDB) may be prevented from being scheduled.

For the convenience of description, the following definitions are given.

First time: a time when a first packet arrives at a transmitting end (e.g., UE). The first packet may be an RLC PDU. For example, the first time may be a time when the first packet arrives at a MAC layer of the transmitting end.

Second time: a time when a second packet is transmitted by the transmitting end (e.g. UE) (or received by a receiving end (e.g. base station)). For example, a starting (or end) time (or starting (or end) symbol) of a channel carrying the second packet transmitted by the transmitting end (e.g., UE) or received by the receiving end (e.g., base station). For another example, a starting (or end) time (or starting (or end) symbol) of a slot where a channel carrying the second packet transmitted by the transmitting end (e.g., UE) or received by the receiving end (e.g., base station) is located. The second packet may contain the first information. The second packet may carry all or part of the data of the first packet. The second packet may carry data of multiple first packets.

Third time: a time when the receiving end (for example, the base station) successfully receives (or decodes) a packet (for example, the first packet).

First time interval: a time interval from the first time to the second time.

Second time interval: a time interval from the second time to the third time.

Third time interval: a time interval from the first time to the third time.

First PDB: a latency requirement that the third time interval should or needs to be satisfied.

First remaining PDB: obtained by subtracting the first time interval from the first PDB.

Second remaining PDB: obtained by subtracting a first predefined time from the first remaining PDB. For example, the first predefined time may be indicated by a parameter configured by higher layer signaling. The first predefined time may indicate a processing time of the base station (e.g., a time for processing or decoding the PUSCH). For example, the first predefined time may be the second time interval.

Third remaining PDB: obtained by subtracting a second predefined time from a PDB (e.g., the first PDB). For example, the second predefined time may be determined based on UE implementation. For another example, the third remaining PDB may be determined based on UE implementation.

The second information may include at least one of:
a first time;
a first PDB;
a first remaining PDB;
a second remaining PDB;
a third remaining PDB;
a size of the first packet; or
a size of the remaining first packet in a logical channel (LCH) buffer. The first packet may be divided into multiple subpackets, and the size of the remaining first packet may be a size of some or all subpackets not included in the second packet.

In some implementations, the first information reported by the UE may include the second information of each of one or more first packets. For example, the first information may include the second information of each of the one or more first packets that satisfy a first predefined condition.

In some examples, for a first packet, the first predefined condition may be a condition to be satisfied for reporting the second information of the first packet. For example, the first predefined condition may include at least one of the following conditions:
a condition that an LCH corresponding to the first packet satisfies a second predefined condition; or
a condition that the second information satisfies a third predefined condition.

For example, for the first packet, the second predefined condition may be a condition to be satisfied by the LCH corresponding to the first packet when the second information of the first packet is reported. For example, the second predefined condition may include at least one of the following conditions:
a condition that the LCH corresponding to the first packet is configured by higher layer signaling to report the second information; or
a condition that an LCG (logical channel group) to which the LCH corresponding to the first packet belongs is configured by higher layer signaling to report the second information.

For the first packet, the third predefined condition may be a condition that the second information of the first packet should satisfy when the second information of the first packet is reported.

In some examples, the first information may be carried by higher layer signaling (e.g., MAC CE) or physical layer signaling (e.g., UCI). The UCI carrying the first information may be a newly defined UCI type or an enhancement to an existing UCI (CG UCI).

This method enables the base station to obtain the latency requirement for uplink data by means of reporting the first information by the UE. On the one hand, this method can make the base station schedule uplink data within the latency requirement as much as possible, and thus can improve the reliability of uplink transmission. On the other hand, when data of an LCH cannot be scheduled within the latency requirement, this method can avoid scheduling packets that exceed the latency requirement, thereby improving the spectrum efficiency of the system.

### Manner MN2

According to embodiments of manner MN2, the third predefined condition may include at least one of the following conditions:
a condition that the first remaining PDB is less than a first predefined threshold;
a condition that the second remaining PDB is less than a second predefined threshold;
a condition that the third remaining PDB is less than a third predefined threshold;
a condition that the first remaining PDB is greater than a fourth predefined threshold;
a condition that the second remaining PDB is greater than a fifth predefined threshold; or
a condition that the third remaining PDB is greater than a sixth predefined threshold.

For example, the above predefined thresholds may be configured by higher layer signaling or specified by protocols.

This method can avoid reporting the second information when the remaining PDB is large or small, so it can reduce unnecessary signaling reporting, and thus saving system spectrum resources. When the remaining PDB is large, even if the second information is not reported, the base station may complete the transmission of uplink data within the latency requirement through scheduling. When the remaining PDB is small, the scheduling of the base station may not satisfy the latency requirement, and the transmission of uplink data cannot be completed within the latency requirement even if the second information is reported at this time.

### Manner MN3

According to embodiments of manner MN3, if the first packet satisfies a fourth predefined condition, then:
the UE flushes the first packet in the LCH buffer; and/or
a BSR (Buffer Status reporting) (for example, the BSR may be a regular BSR) is triggered; and/or
a specific SR is triggered.

In some implementations, the fourth predefined condition may include at least one of the following conditions:
a condition that the first remaining PDB is less than a seventh predefined threshold;
a condition that the second remaining PDB is less than an eighth predefined threshold; or
a condition that the third remaining PDB is less than a ninth predefined threshold.

For example, the above predefined thresholds may be configured by higher layer signaling or specified by protocol.

This method can reduce the transmission of uplink data that does not satisfy the PDB requirement by flushing the LCH buffer. By triggering the BSR, the updated buffer information can be notified to the base station, and thus the unnecessary uplink scheduling can be avoided, thereby improving the spectrum efficiency.

### Manner MN4

According to embodiments of manner MN4, the UE may transmit a PUCCH indicating that there is no uplink data to be transmitted. For example, the indication may be explicit or implicit. As an example, the PUCCH includes information indicating that there is no uplink data to be transmitted (for example, the BSR is empty or the LCH buffer is flushed). As another example, it may be indicated that there is no uplink data to be transmitted by negative SR carried in the PUCCH. For example, it is indicated that the BSR is empty or the LCH buffer is flushed by transmitting the PUCCH with the negative SR (for example, a PUCCH with only negative SR). In this way, the unnecessary uplink scheduling can be avoided, thereby improving spectrum efficiency.

### Manner MN5

According to embodiments of manner MN5, if a MAC PDU satisfies a fifth predefined condition, the UE flushes a HARQ buffer corresponding to the MAC PDU. For example, the HARQ buffer corresponding to the MAC PDU may be the HARQ buffer used for transmitting the MAC PDU.

In some implementations, for a MAC PDU, the fifth predefined condition may include at least one of the following conditions:
a condition that a first packet contained in (or corresponding to) the MAC PDU satisfies the fourth predefined condition. For example, all the first packets contained in (or corresponding to) the MAC PDU satisfy the fourth predefined condition.
the PUSCH for transmitting (or carrying) the MAC PDU is a CG PUSCH.

In some implementations, if the UE is scheduled with a dynamic uplink grant indicating retransmission of a HARQ process, and a MAC PDU corresponding to the HARQ process satisfies the fifth predefined condition, the UE does not transmit the PUSCH indicated by the uplink grant. In this way, the power consumption of the UE can be saved and the interference to other UEs can be reduced.

In some implementations, if a HARQ process is configured for a configured uplink grant, and a MAC PDU corresponding to the HARQ process satisfies the fifth predefined condition, the UE performs at least one of the following operations:
stopping a configured grant retransmission timer (e.g., cg-RetransmissionTimer).
stopping a configured grant timer (e.g., configuredGrantTimer).

In this way, the configured grant (e.g., the configured grant resource) corresponding to the HARQ process can become available, thereby reducing the uplink transmission delay.

In the embodiments of the disclosure, for example, the dynamic uplink grant may refer to an uplink grant dynamically received on a PDCCH. For example, the configured uplink grant may refer to an uplink grant semi-persistently configured by higher layer signaling (e.g., RRC signaling).

### Manner MN6

According to embodiments of manner MN6, if the UE is scheduled with a dynamic uplink grant indicating a HARQ process, it can be configured by higher layer signaling that the UE can report third information related to the HARQ process through UCI in a PUSCH indicated by the uplink grant.

For example, the third information may include at least one of:
an NDI (new data indicator);
an MCS (modulation and coding scheme); or
a RV (redundancy version).

As an example, if the UE is scheduled with a dynamic uplink grant indicating retransmission of a HARQ process, and a MAC PDU corresponding to the HARQ process satisfies the fifth predefined condition, the UE can transmit a new MAC PDU in the PUSCH indicated by the dynamic uplink grant, and report information related to the new MAC PDU to the base station through UCI.

The information related to the new MAC PDU includes at least one of:
an NDI;
an MCS; or
a RV.

In this way, the transmission delay of uplink data can be reduced, thereby improving the spectrum efficiency of the system.

FIG. 7 illustrates a flowchart of a method 700 performed by a terminal according to some embodiments of the disclosure.

Referring to FIG. 7, in operation S710, the terminal receives a physical downlink channel including configuration information.

Continuing to refer to FIG. 7, in operation S720, the terminal transmits a physical uplink channel. The physical uplink channel may include a PUSCH and/or a PUCCH.

In some implementations, the operations S710 and/or S720 may be performed based on methods described according to various embodiments of the disclosure (e.g., in manners MN1-MN6).

In some implementations, the method 700 may omit the operation S710, or include additional operations, for example, operations performed by a terminal (e.g., UE) according to various embodiments of the disclosure (e.g., in manners MN1-MN6).

FIG. 8 illustrates a block diagram of a first transceiving node 800 according to some embodiments of the disclosure.

Referring to FIG. 8, the first transceiving node 800 may include a transceiver 801 and a controller 802.

The transceiver 801 may be configured to transmit first data and/or first control signaling to a second transceiving node and receive second data and/or second control signaling from the second transceiving node in a time unit.

The controller 802 may be an application specific integrated circuit or at least one processor. The controller 802 may be configured to control the overall operation of the first transceiving node, including controlling the transceiver 801 to transmit first data and/or first control signaling to the second transceiving node and receive second data and/or second control signaling from the second transceiving node in a time unit.

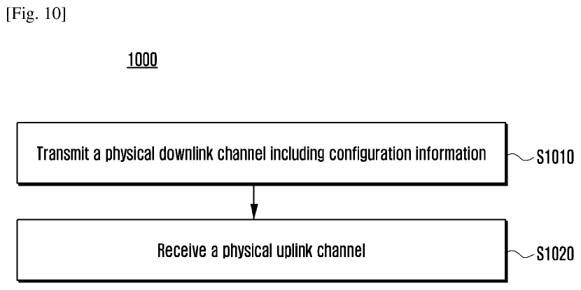

In some implementations, the controller 802 may be configured to perform one or more operations in the methods of the various embodiments described above, for example, the operations in the method to be described in connection with FIG. 9, the operations in the method to be described in connection with FIG. 10, and/or the operations performed by the base station according to various embodiments of the disclosure (e.g., in manners MN1-MN6).

In the following description, the base station is taken as an example (but not limited to this) to explain the first transceiving node, and the UE is taken as an example (but not limited to this) to explain the second transceiving node. Downlink data and/or downlink control signaling (but not limited to this) is taken to explain the first data and/or the first control signaling. A HARQ-ACK codebook may be included in second control signaling, which is explained by uplink control signaling (but not limited to this).

FIG. 9 illustrates a flowchart of a method 900 performed by a base station according to some embodiments of the disclosure.

Referring to FIG. 9, in step S910, a base station transmits downlink data and/or downlink control information.

In step S920, the base station receives second data and/or second control information from a UE in a time unit.

For example, the method 900 may include one or more of the operations performed by the base station described in various embodiments of the disclosure (e.g., in manners MN1-MN6).

FIG. 10 illustrates a flowchart of a method 1000 performed by a base station according to some embodiments of the disclosure.

Referring to FIG. 10, in step S1010, a physical downlink channel including configuration information is transmitted to the terminal.

In step S1020, a physical uplink channel is received from the terminal. For example, the physical uplink channel may include physical uplink shared channel (PUSCH) and/or physical uplink control channel (PUCCH).

In some implementations, operations S1010 and/or S1020 may be performed based on methods described according to various embodiments of the disclosure (e.g., in manners MN1-MN6).

In some implementations, the method 1000 may omit operation S1010, or include additional operations, for example, the operations performed by the base station according to various embodiments of the disclosure (e.g., in manners MN1-MN6). Those skilled in the art will understand that the above illustrative embodiments are described herein and are not intended to be limiting. It should be understood that any two or more of the embodiments disclosed herein may be combined in any combination. Furthermore, other embodiments may be utilized and other changes may be made without departing from the spirit and scope of the subject matter presented herein. It will be readily understood that aspects of the invention of the disclosure as generally described herein and shown in the drawings may be arranged, replaced, combined, separated and designed in various different configurations, all of which are contemplated herein.

Those skilled in the art will understand that the various illustrative logical blocks, modules, circuits, and steps described in this application may be implemented as hardware, software, or a combination of both. To clearly illustrate this inter-changeability between hardware and software, various illustrative components, blocks, modules, circuits, and steps are generally described above in the form of their functional sets. Whether such function sets are implemented as hardware or software depends on the specific application and the design constraints imposed on the overall system. Technicians may implement the described functional sets in different ways for each specific application, but such design decisions should not be interpreted as causing a departure from the scope of this application.

The various illustrative logic blocks, modules, and circuits described in this application may be implemented or performed by a general purpose processor, a Digital Signal Processor (DSP), an Application Specific Integrated Circuit (ASIC), a Field Programmable Gate Array (FPGA) or other programmable logic devices, discrete gates or transistor logics, discrete hardware components, or any combination thereof designed to perform the functions described herein. The general purpose processor may be a microprocessor, but in an alternative, the processor may be any conventional processor, controller, microcontroller, or state machine. The processor may also be implemented as a combination of computing devices, such as a combination of a DSP and a microprocessor, multiple microprocessors, one or more microprocessors cooperating with a DSP core, or any other such configuration.

The steps of the method or algorithm described in this application may be embodied directly in hardware, in a software module executed by a processor, or in a combination thereof. The software module may reside in RAM memory, flash memory, ROM memory, EPROM memory, EEPROM memory, register, hard disk, removable disk, or any other form of storage medium known in the art. An exemplary storage medium is coupled to a processor to enable the processor to read and write information from/to the storage media. In an alternative, the storage medium may be integrated into the processor. The processor and the storage medium may reside in an ASIC. The ASIC may reside in a communication apparatus. In an alternative, the processor and the storage medium may reside in the communication apparatus as discrete components.

In one or more exemplary designs, the functions may be implemented in hardware, software, firmware, or any combination thereof. If implemented in software, each function may be stored as one or more pieces of instructions or codes on a computer-readable medium or delivered through it. The computer-readable medium includes both a computer storage medium and a communication medium, the latter including any medium that facilitates the transfer of computer programs from one place to another. The storage medium may be any available medium that can be accessed by a general purpose or special purpose computer.

The above description is only an exemplary implementation of the present invention, and is not intended to limit the scope of protection of the present invention, which is determined by the appended claims.

1-15. (canceled)

16. A method performed by a terminal in a wireless communication system, the method comprising:
receiving, from a base station, a message including information on a threshold associated with a remaining time for triggering a delay status reporting for a logical channel within a logical channel group (LCG);
identifying whether a remaining value is below the threshold; and
in case that the remaining value is below the threshold, transmitting, to the base station, information on a delay status for at least one LCG.

17. The method of claim 16, wherein the information on the delay status for the at least one LCG is transmitted by a medium access control (MAC) control element (CE).

18. The method of claim 16, wherein the information on the delay status for the at least one LCG includes information associated with a transmission delay of uplink data.

19. The method of claim 16, wherein the message further includes information on the at least one LCG.

20. A method performed by a base station in a wireless communication system, the method comprising:
transmitting, to a terminal, a message including information on a threshold associated with a remaining time for triggering a delay status reporting for a logical channel within a logical channel group (LCG); and
in case that a remaining value is below the threshold, receiving, from the terminal, information on a delay status for at least one LCG.

21. The method of claim 20, wherein the information on the delay status for the at least one LCG is received by a medium access control (MAC) control element (CE).

22. The method of claim 20, wherein the information on the delay status for the at least one LCG includes information associated with a transmission delay of uplink data.

23. The method of claim 20, wherein the message further includes information on the at least one LCG.

24. A terminal in a wireless communication system, the terminal comprising:
a transceiver; and
at least one processor coupled with the transceiver and configured to:
receive, from a base station, a message including information on a threshold associated with a remaining time for triggering a delay status reporting for a logical channel within a logical channel group (LCG),
identify whether a remaining value is below the threshold, and
in case that the remaining value is below the threshold, transmit, to the base station, information on a delay status for at least one LCG.

25. The terminal of claim 24, wherein the information on the delay status for the at least one LCG is transmitted by a medium access control (MAC) control element (CE).

26. The terminal of claim 24, wherein the information on the delay status for the at least one LCG includes information associated with a transmission delay of uplink data.

27. The terminal of claim 24, wherein the message further includes information on the at least one LCG.

28. A base station in a wireless communication system, the base station comprising:
a transceiver; and
at least one processor coupled with the transceiver and configured to:
transmit, to a terminal, a message including information on a threshold associated with a remaining time for triggering a delay status reporting for a logical channel within a logical channel group (LCG), and
in case that a remaining value is below the threshold, receive, from the terminal, information on a delay status for at least one LCG.

29. The base station of claim 28, wherein the information on the delay status for the at least one LCG is received by a medium access control (MAC) control element (CE).

30. The base station of claim 28, wherein the information on the delay status for the at least one LCG includes information associated with a transmission delay of uplink data.

31. The base station of claim 28, wherein the message further includes information on the at least one LCG.
